(19) United States
(12) Patent Application Publication
(10) Pub. No.: US 2022/0382250 A1
(43) Pub. Date: Dec. 1, 2022

(54) POWDER BED DEFECT DETECTION AND MACHINE LEARNING

(71) Applicant: Sigma Labs, Inc., Santa Fe, NM (US)

(72) Inventors: Roger Frye, Santa Fe, NM (US); Christina Xuan Yu, Albuquerque, NM (US); Darren Beckett, Corrrales, NM (US); Martin S. Piltch, Los Alamos, NM (US); Lars Jacquemetton, Santa Fe, NM (US); Kevin C. Anderson, Santa Fe, NM (US)

(73) Assignee: Sigma Labs, Inc., Santa Fe, NM (US)

(21) Appl. No.: 17/828,258

(22) Filed: May 31, 2022

Related U.S. Application Data
(60) Provisional application No. 63/195,604, filed on Jun. 1, 2021.

(51) Int. Cl. G05B 19/4099; G01N 21/88

(52) U.S. Cl. CPC G05B 19/4099; G01N 21/8851; G01N 2021/8887; G05B 2219/49023

(57) ABSTRACT

In some aspects, the additive manufacturing system may access, by a processor of an additive manufacturing system, a machine learning model that is trained to identify defects within a build plane. Also, the additive manufacturing system may capture, by an imaging system of the additive manufacturing system, an image of a build plane of the additive manufacturing system. The build plane can contain an object being manufactured through an additive manufacturing process. In addition, the additive manufacturing system may provide, by the processor, the captured image as an input to the machine learning model. Moreover, the additive manufacturing system may receive, by the processor, an output from the machine learning model identifying a defect in the build plane.

### CROSS-REFERENCES TO RELATED APPLICATIONS

This application claims priority to U.S. Provisional Patent Application No. 63/195,604 filed on Jun. 1, 2021, the disclosure of which is hereby incorporated by reference in its entirety for all purposes.

### BACKGROUND OF THE INVENTION

Additive manufacturing, or the sequential construction of a part through the combination of material addition and applied energy, takes on many forms and currently exists in numerous implementations and embodiments. Additive manufacturing can be carried out by using any of a number of various processes that involve the formation of a 3-D part of any shape.

The various processes that are used for making metallic parts have in common the sintering and/or melting of powdered or granular raw material, layer by layer using one or more high power energy sources such as a laser or electron beam. The generation of defects in the finished part can be caused by multiple sources, including those caused by the recoater arm which deposits a new layer of metallic powder that is to be fused to the underlying part. Such defects can be difficult to track or detect and can result in machine stoppage and/or degradation of material properties of the finished part. New methods to detect and characterize defects in additive manufacturing systems are needed.

### BRIEF SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, techniques may include accessing a machine learning model that is trained to identify defects within a build plane. The techniques may in addition include capturing an image of the build plane of the additive manufacturing system. The image may be captured by an imaging system of the additive manufacturing system. The build plane may include a layer of powder extending across one or more objects being manufactured through an additive manufacturing process. The techniques may also include providing the captured image as an input to the machine learning model. The techniques may further include receiving an output from the machine learning model identifying a defect in the build plane. Other embodiments of this aspect include corresponding methods, computer systems, apparatus, and computer programs recorded on one or more computer storage devices, each configured to perform the actions of the techniques.

Implementations may include one or more of the following features. The techniques may include determining if the defect can be corrected. The techniques may include generating one or more control signals for one or more in process parameters in response a determination that the identified defect can be corrected. The one or more control signals can be configured to correct the defect. The techniques may include terminating the additive manufacturing process in response to a determination that the identified defect cannot be corrected. The techniques may include providing the output of the machine learning model to a display device of the additive manufacturing system. The techniques may include techniques where the output from the machine learning model includes a defect type for the identified defect. The techniques may include techniques where accessing the machine learning model further may include selecting the machine learning model from a model warehouse based on at least one of a part geometry, a powder bed layout, a powder material, a lighting angle, or a lighting type. Implementations of the described techniques may include hardware, a method or process, or a computer tangible medium.

### BRIEF DESCRIPTION OF THE DRAWINGS

FIG. 1 shows an example additive manufacturing system according to an embodiment.

FIG. 2 illustrates an image of a powder bed according to an embodiment.

FIG. 3 illustrates a processed image according to an embodiment.

FIG. 4 illustrates a machine learning image that is derived from a processed image according to an embodiment.

FIG. 5 illustrates a visual summary of one embodiment of a machine learning process.

FIG. 6 is a flowchart of an example process according to an embodiment.

FIG. 7 shows an example additive manufacturing system according to an embodiment.

### DETAILED DESCRIPTION

Some embodiments of the present disclosure relate to methods of detecting defects in an additive manufacturing system. While the present disclosure can be useful for a wide variety of configurations, some embodiments of the disclosure are particularly useful for employing one or more in-process metrics along with machine learning to detect and identify powder bed defects caused by the recoater arm of additive manufacturing system, as described in more detail below.

Additive manufacturing systems commonly use a recoater arm to deposit a new layer of material after the previous layer has been fused to the underlying part. In metallic additive manufacturing systems often the new layer is a layer of metallic powder that is smoothed to a uniform thickness across the underlying part by a recoater arm that traverses the powder bed. In some cases the recoater arm height may unintentionally vary due to the effects of an underlying part (e.g., a long edge of an underlying part is aligned with the recoater arm) causing variations in a height of the powder. This variation in height can result in defects within part(s) and/or physical stoppage of the recoater arm when the variations accumulate over time causing a ridge to form in the part that interferes with movement of the recoater arm. Machine stoppage may result in a significant yield loss, or at a minimum downtime and lost productivity. An imaging system can be used to scan the powder bed after the recoater arm traverses the powder bed to detect any potential defects and/or risk of recoater arm stoppage. Machine learning models can be employed to analyze the images and identify regions of risk before they cause defects and/or result in the stoppage of the system, as explained in more detail below.

Several illustrative embodiments will now be described with respect to the accompanying drawings, which form a part hereof. The ensuing description provides embodiment(s) only and is not intended to limit the scope, applicability, or configuration of the disclosure. Rather, the ensuing description of the embodiment(s) will provide those skilled in the art with an enabling description for implementing one or more embodiments. It is understood that various changes may be made in the function and arrangement of elements without departing from the spirit and scope of this disclosure. In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

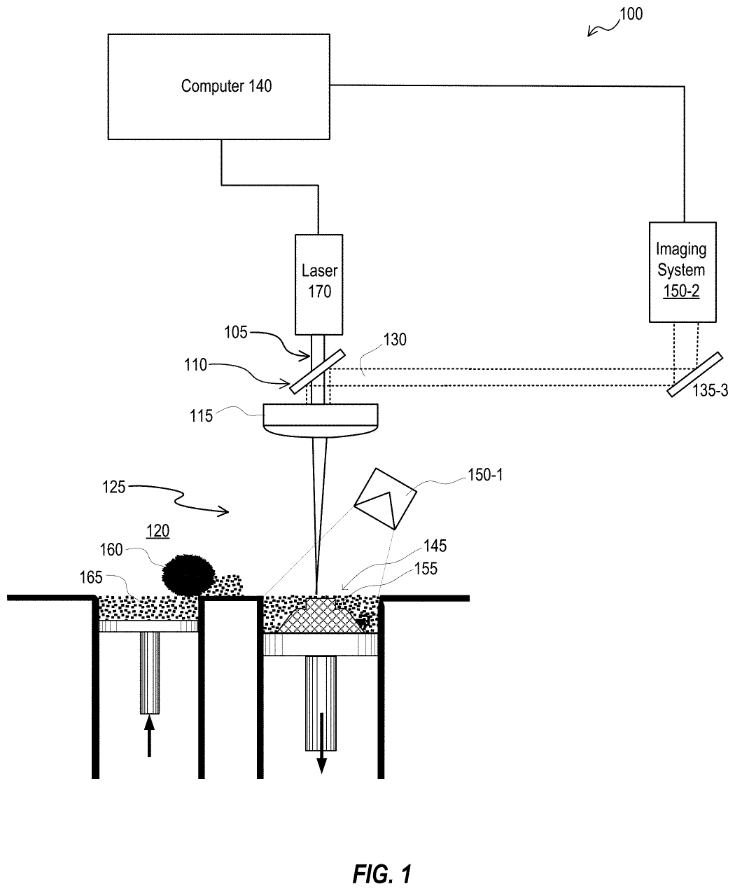

FIG. 1 shows an example additive manufacturing system according to an embodiment. Additive manufacturing system 100 is equipped with one or more imaging systems 150 that can image powder bed on build plane 145 to detect potential defects in part(s) 155 and/or operation of recoater arm 160. Additive manufacturing system 100 uses a laser 170 as an energy source. The laser 170 emits a laser beam 105 which passes through a partially reflective mirror 110 and enters a scanning and focusing system 115 which then projects the beam to a region on build plane 145. In some embodiments, build plane 145 is a powder bed upon which metallic powder 165 has been dispersed.

In some embodiments, scanning and focusing system 115 can be configured to collect an image of powder bed on build plane 145 via imaging system 150-2 (e.g., on-axis imaging). In further embodiments imaging system 150-1 (e.g., off-axis imaging) can collect an image of powder bed on build plane 145. Examples of imaging systems 150 are a CCD-based imaging device, a CMOS-based imaging device, 2D or 3D a laser scanner, an optical profilometer, low-coherence interferometry, thermography or any other suitable imaging system. Images can be transferred to computer 140 for analysis that may include one or more machine learning algorithms, as described in more detail below. BUILD PLANE IMAGES

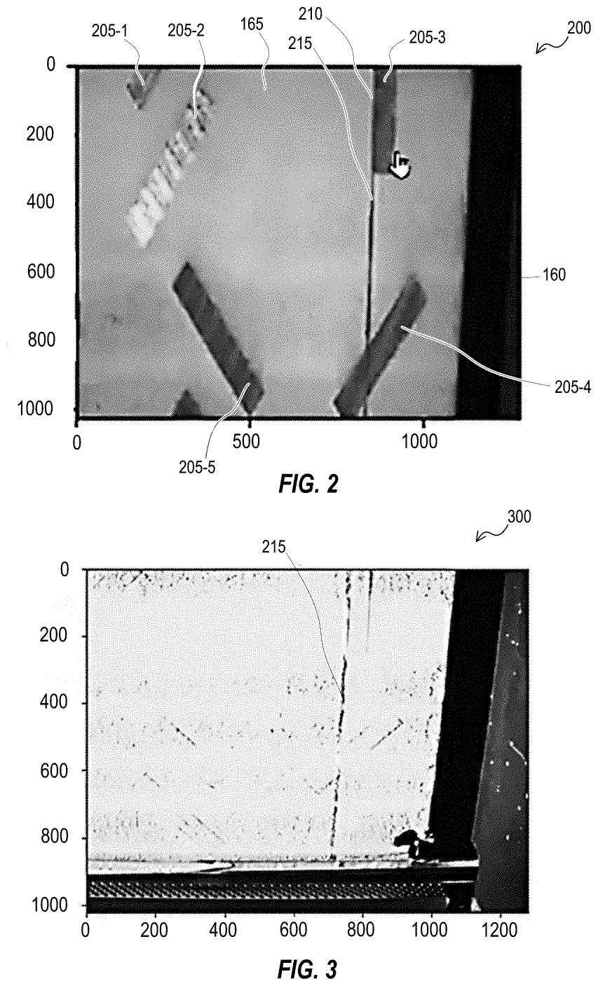

FIG. 2 illustrates an image 200 of powder bed on build plane 145 (see FIG. 1) captured by imaging system 150 after recoater arm 160 has deposited a layer of powder 165. As shown in FIG. 2, image 200 includes features 205-1 . . . 205-5 that can be created from underlying parts. Feature 205-3 has an edge 2094 that is aligned with recoater arm 160. In this particular image, edge 2094 has caused recoater arm 160 to catch slightly, creating a ridge 215 of powder that extends across the entire powder bed on build plane 145 including extending across feature 205-4 and the underlying part. If left undetected ridge 215 may cause defects to be formed in parts underlying features 205-3 and 205-4 and/or may cause recoater arm 160 to jam.

FIG. 3 illustrates a processed image 300 of image 200. Processed image 300 can be analyzed by computer 140 (see FIG. 1) using any suitable algorithm to detect and/or identify defects in the powder bed on build plane 145. In this particular processed image, ridge 215 has been identified and highlighted. Such an image can be presented to an operator, identifying the defect and/or used for further analysis.

The image processing techniques can include digital image transformations such as filtering techniques or affine transformations. Filtering techniques can include spectral lowpass filtering, spectral highpass filtering, Fourier representation filtering, Fourier lowpass filtering, Fourier highpass filtering, etc. The images may be padded before filtering. Affine transformations can include identity transformations, reflection, transformations by a scale ratio, rotations, or transformation by a shear matrix. The image can be denoised using various techniques including dilation, erosion, opening, closing, etc.

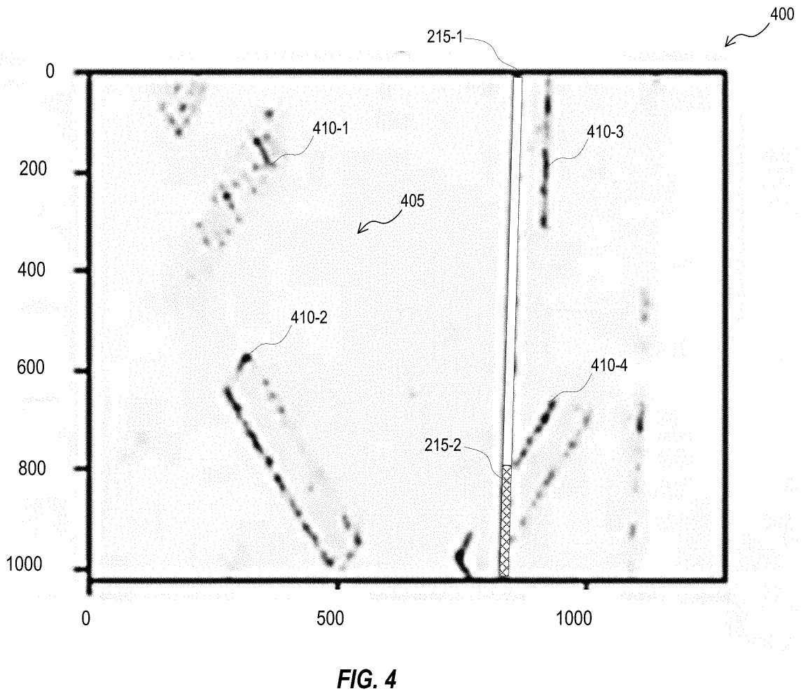

FIG. 4 illustrates a machine learning image 400 that is derived from processed image 300 shown in FIG. 3. As shown in FIG. 4, machine learning image 400 represents the accuracy of a particular machine learning model to predictively identify a ridge 215. More specifically, the box indicated by 215-1 identifies true positives (e.g., where ridge 215 was predicted and where it empirically occurred). False positives 410 indicate where defects were predicted but did not empirically occur. White 405 identifies true negatives (e.g., where no defects were predicted and empirically no defects occurred). The checkered box 215-2 identifies false negatives (e.g., where no defect was predicted but empirically an defect occurred). As shown, the majority of the ridge 215 is covered by box 215-1, verifying that the machine learning model successfully predictively identified the ridge before actual defects occurred, which could include generating defects in the parts and/or machine stoppage. Such models can be used to predict defects while in the build process and to either alert an operator before defects occur or to take autonomous corrective action. As appreciated by one of ordinary skill in the art the methods of identifying defects within the powder bed can be applied to any suitable additive manufacturing process including, but not limited to fused and/or cured polymer systems, ceramic systems, etc.

### Machine Learning Process

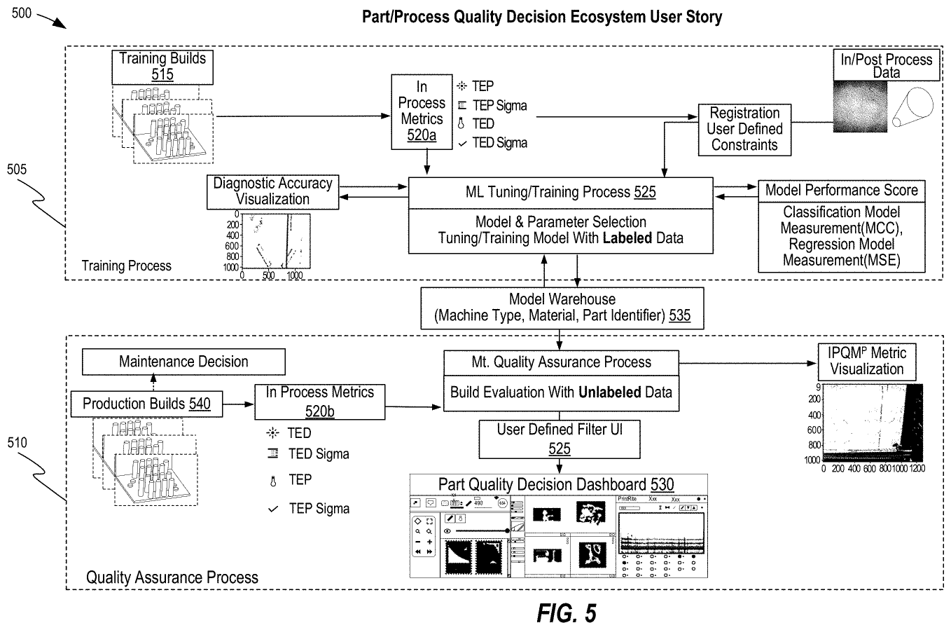

FIG. 5 illustrates a visual summary of one embodiment of a machine learning process 500 that can be used to identify defects generated by an additive manufacturing system. As shown in FIG. 5, the process is broken up into a training process 505 and a quality assurance process 510. Starting first with the training process, training builds 515 of parts manufactured with the additive manufacturing system are performed. During the manufacturing, in process metrics 520a are collected. In some embodiments these training builds 515 can have induced defects such that known defects are introduced into the parts and/or powder bed and can be used to train the machine learning algorithm, explained in greater detail below. The parts and/or powder bed having known defects can then be analyzed with either non-destructive or destructive tests to verify and map the location of the defects. This data can be overlaid with the in-process metrics 520a and used as “training data” to train the machine learning algorithm as part of a machine learning (ML) tuning/training process 505.

In process metrics 520a can include Thermal Emission Density (TED) and Thermal Emission Plank (TEP). One particular method of determining TED metrics is explained in more detail in U.S. Pat. No. 10,639,745 titled Systems And Methods For Measuring Radiated Thermal Energy During An Additive Manufacturing Operation, which is incorporated by reference herein in its entirety for all purposes. One particular method of determining TEP metrics is explained in more detail in U.S. application Ser. No. 10,479,020 titled Systems And Methods For Measuring Radiated Thermal Energy During An Additive Manufacturing Operation, which is incorporated by reference herein in its entirety for all purposes.

As described herein, a machine learning algorithm is an application of artificial intelligence that provides systems the ability to automatically learn and improve from experience without being explicitly programmed. Typically, parameters are selected for one or more machine learning algorithms to build a mathematical model. The parameters can include hyperparameters that control the learning process and learned parameters that are determined during training. A machine learning algorithm can be trained using sample data, often called “training data”, to produce a machine learning model that can make predictions or decisions without being explicitly programmed to do so. In some embodiments machine learning can include the use of a convolutional neural network (CNN). For a neural network, the model parameters can be the total number of nodes, the number of nodes in a layer, the number of layers, and the weights for connections between nodes.

To train a machine learning model from a machine learning algorithm, images with known defects (e.g., training data) can be provided as input to the machine learning algorithm during training. The machine learning algorithm can output a classification for the input training data, and, during training, the model parameters can be modified until the output classification for a the input training data matches a known classification for the image. The classification can be a label (e.g. “defect detected” or “no defect detected”) for individual pixels in the image, sections of an image, or identified objects within the image. The classification can be that the image contains a defect or that the image does not contain a defect.

Once the algorithm properly classifies the training data, the algorithm can be tested on verification data. The verification data can be images, with known classifications, that were not used earlier in the training process. If the machine learning algorithm correctly classifies the verification data, the machine learning algorithm can be a machine learning model.

In some instances, the training data may not have a known classification when is input into the machine learning algorithm. For instance, a machine learning algorithm may be trained by classifying images of one or more objects created during an additive manufacturing process. After manufacturing, the objects can be inspected and defects can be identified. The classifications produced by the algorithm during manufacturing can be compared against the identified defects and the machine learning algorithm's performance can be evaluated.

Examples of machine learning models include deep learning models, neural networks (e.g., deep learning neural networks), kernel-based regressions, adaptive basis regression or classification, Bayesian methods, ensemble methods, logistic regression and extensions, Gaussian processes, support vector machines (SVMs), a probabilistic model, and a probabilistic graphical model. Embodiments using neural networks can employ using wide and tensorized deep architectures, convolutional layers, dropout, various neural activations, and regularization steps.

In some embodiments CNN can be employed to learn and generate predictions using an entire image (e.g., FIGS. 2 and 3). More specifically, the CNN can identify one or more features in an image and the classification can be a prediction of whether or not there will be a “failure”.

In other embodiments a U-net, YOLO, or other type of model can be used to evaluate each pixel of a particular image and identify precisely which pixel(s) are likely to result in a “failure”. For example, the individual pixels can be classified as containing a defect. An example of this type of model is shown in FIG. 4 where the red pixels indicate likely “failure” areas.

Prediction Metrics (e.g., classifications; the image output of the Neural Network) can be used to identify locations of potential defects and make decisions on what to do, sometimes before the defect occurs. In one embodiment the machine autonomously monitors the images of the powder bed and as soon as one or more pixels show up as probable defects the system could pause and wait for the user. The machine shows the image to the user where it identifies the problematic pixels so the user can make an informed decision. The image can be presented to the users through the user defined filter user interface (UI) 525 or the part quality decision dashboard 530. The number of problematic pixels, the location of each of the problematic pixels, etc. can be used as metrics to determine when to pause the machine. For example, only one lone problematic pixel may not cause the machine to pause, however, a plurality of closely spaced problematic pixels arranged in a line likely represents a recoater arm jump and may cause the machine to pause. One of skill in the art having the benefit of this disclosure can appreciate the other ways in which a machine learning model can be used to identify potential defects, commmunicate to an operator and control operation of the machine.

In some embodiments different part geometries, powder bed layouts, different powder materials, lighting angles, lighting types etc. can be used to create different machine learning models that can be tailored to specific parts and/or powder bed configurations. In other embodiments generic machine learning models can be developed that can handle varied part geometries, powder bed configurations and materials.

Now transitioning to the quality assurance process 510 in FIG. 5, a machine learning model can be selected from a model warehouse 535. Production builds can be initiated and in process metrics 520b can be collected during the build process. These in metrics 520b can be used as an input into the machine learning model, and the machine learning model can output real-time data detecting and/or identifying defects in the powder bed and/or parts during production builds. As shown in FIG. 5 the output from the machine learning model can be displayed to a user via the user defined filter user interface (UI) 525, the part quality decision dashboard 530, or through a “Visualization” user interface. As would be appreciated by one of skill in the art having the benefit of this disclosure, various other methods of displaying and using the output of the machine learning model can be used and are within the scope of this disclosure. Thus, by employing a trained machine learning model, real-time defect analysis and/or identification can be performed, and an operator, or the additive manufacturing system can make decisions with regard to the defective powder bed and/or parts. In one example the system can take action to repair the defect, while in another example the system can cease building and notify an operator.

### Method Flow

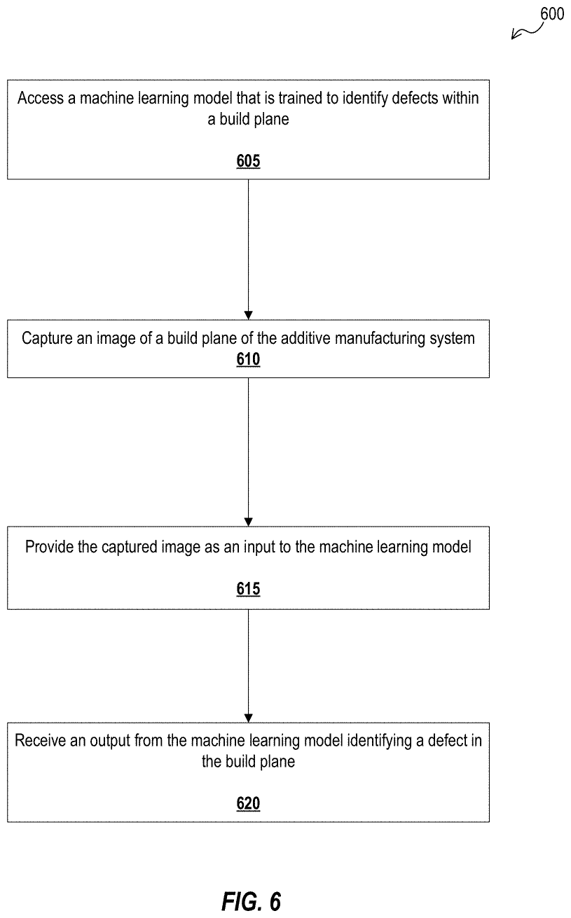

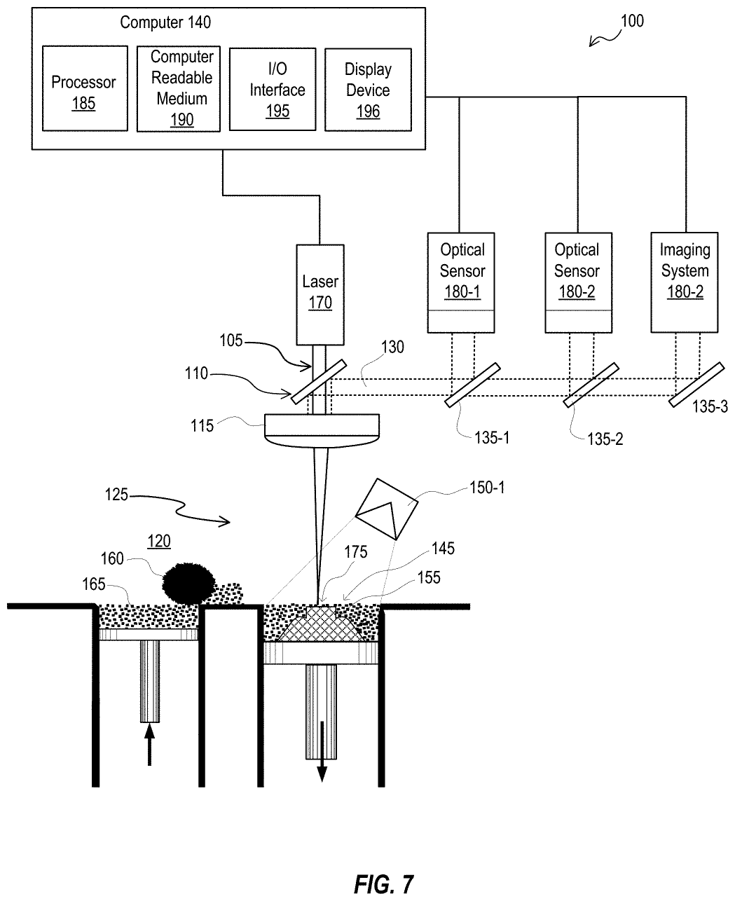

FIG. 6 is a flowchart of an example process 600. In some implementations, one or more process blocks of FIG. 6 may be performed by an additive manufacturing system such as the systems shown in FIG. 1 and FIG. 7.

At block 605, a machine learning model may be accessed. The machine learning model may be accessed by a computing device of an additive manufacturing system such as computer 140. The machine learning model may be trained to detect defects within a build plane such as build plane 145. The machine learning model may be accessed from a computer readable medium such as computer readable medium 2020. The machine learning model may be accessed from a computer readable medium outside of the additive manufacturing system via I/O interface 2022. In some circumstances, the machine learning model can be accessed from a database of machine learning models (e.g., model warehouse 535). The machine learning model can be selected based on at least one of a part geometry, a powder bed layout, a powder material, a lighting angle, a lighting type, etc.

At block 605, a machine learning model may be accessed. The machine learning model may be accessed by a computing device of an additive manufacturing system such as computer 140. The machine learning model may be trained to detect defects within a build plane such as build plane 145. The machine learning model may be accessed from a computer readable medium such as computer readable medium 2020. The machine learning model may be accessed from a computer readable medium outside of the additive manufacturing system via I/O interface 2022. In some circumstances, the machine learning model can be accessed from a database of machine learning models (e.g., model warehouse 535). The machine learning model can be selected based on in process metrics such as in process metrics 520. The in process metrics can include a part geometry, a powder bed layout, a powder material, a lighting angle, a lighting type, etc. The machine learning model can be a convolutional neural network (CNN).

At block 610, an image of a build plane of the additive manufacturing system can be captured. The image can be captured by an imaging system such as imaging system 150-1, imaging system 150-2, optical sensor 180-1, optical sensor 180-2, etc.

At block 615, the captured image can be provided as an input to the machine learning model. The image may be processed before it is input into the machine learning model. For instance, digital image transformation, such as filtering techniques or affine transformations, can be applied to the image before the image is input to the machine learning model. The image may be denoised before the image is input to the machine learning model.

At block 620, an output from the machine learning model can be received. The output from the machine learning model can identify a defect in the build plane. The output from the machine learning model can be an image that has been modified to indicate the presence of anomalies such as the image depicted in FIG. 4. For instance, the color of pixels in the image can be modified to show whether the model detected defects in the image. For instance, red can indicate false negatives, blue indicates false positives, and green indicates true positives. In some instances, the output from the machine learning model can be a probability that the input to the machine learning model contains a defect. For instance, the output from the machine learning model can be a tuple comprising a probability that the input contains a defect and a probability that a machine learning model does not contain a defect with both probabilities summing to one.

In some instances, the output from the machine learning model may indicate whether an identified defect can be corrected. In some instances, a computer of the additive manufacturing system (e.g., computer 140) may use the output from the machine learning model, and in process metrics, to determine whether the output can be corrected. The computer may cause the additive manufacturing system to take corrective action to fix the defect. For instance, the computer may generate control signals for one or more in process parameters to correct the defect. The computer may determine that the defect cannot be corrected. If it is determined that the defect cannot be corrected, the computer may cause the additive manufacturing system to stop manufacturing an object. In some circumstances, the output may be provided to a display device such as display device 196.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

### Example Additive Manufacturing System

FIG. 7 shows an example additive manufacturing system that includes the two imaging systems 150-1 and 150-2 described above and also includes two optical sensors 180-1 and 180-2 that monitor discrete wavelengths of light to characterize temperature variations in real-time occurring on a build plane to determine thermal energy density and/or other parameters. The additive manufacturing system of FIG. 7 uses a laser 170 as the energy source. The laser 170 emits a laser beam 105 which passes through a partially reflective mirror 110 and enters a scanning and focusing system 115 which then projects the beam to a region 2004 on build plane 145. In some embodiments, build plane 145 is a powder bed. Optical energy 125 is emitted from region 2004 on account of high material temperatures and emissivity properties of the materials receiving being irradiated by laser beam 105.

In some embodiments, the scanning and focusing system 115 can be configured to collect some of the optical energy 125 emitted from region 175. In some embodiments, a melt pool and luminous plume can cooperatively emit blackbody radiation from within region 175. The melt pool is the result of powdered metal liquefying due to the energy imparted by laser beam 105 and is responsible for the emission of most of the optical energy being reflected back toward focusing system 115. The luminous plume results from vaporization of portions of the powdered metal. The partially reflective mirror 110 can reflect most of the optical energy received by focusing system 115. The optical energy 130 may be interrogated by on-axis optical sensors 2009-1 and 2009-2. Each of the on-axis optical sensors 180 receive a portion of optical energy 130 through mirrors 135-1 and 135-2. In some embodiments, mirrors 135 can be configured to reflect only wavelengths λ₁ and λ₂, respectively. In some embodiments, optical sensors 180-1 and 180-2 receive a total of 80-90% of the light reflected through the optics train.

Optical sensors 180-1 and 180-2 can also include notch filters that are configured to block any light outside of respective wavelengths λ₁ and λ₂. Third optical sensor 180-3 can be configured to receive light from partially reflective mirror 110. In some embodiments, optical sensors 180-1 and 180-2 can be covered by notch filters while imaging system 150-2 can be configured to measure a much larger range of wavelengths. In some embodiments, optical sensor 180-1 or 180-2 can be replaced with a spectrometer configured to perform an initial characterization of a blackbody radiation curve associated with a batch of powder being used to perform an additive manufacturing process. This characterization can then be used to determine how the wavelength filters of optical sensors 180-1 and 180-2 are configured to be offset and avoid any spectral peaks associated with the black body curve characterized by the spectrometer. This characterization is performed prior to a full additive manufacturing operation being carried out.

It should be noted that the collected optical energy 130 may not have the same spectral content as the optical energy emitted from the beam interaction region 175 because the optical energy 130 has suffered some attenuation after going through multiple optical elements such as partially reflective mirror 110, scanning and focusing system 115, and one or more of partially reflective mirrors 135. These optical elements may each have their own transmission and absorption characteristics resulting in varying amounts of attenuation that thus limit certain portions of the spectrum of energy radiated from the beam interaction region 175. The data generated by on-axis optical sensors 180 may correspond to an amount of energy imparted on the work platform. This allows the notch feature wavelengths to be selected to avoid frequencies that are overly attenuated by absorption characteristics of the optical elements.

Examples of on-axis optical sensors 180 include but are not limited to photo to electrical signal transducers (i.e. photodetectors) such as pyrometers and photodiodes. The optical sensors can also include spectrometers, and low or high speed cameras that operate in the visible, ultraviolet, or the infrared frequency spectrum. The on-axis optical sensors 180 are in a frame of reference which moves with the beam, i.e., they see all regions that are touched by the laser beam and are able to collect optical energy 130 from all regions of the build plane 145 touched as the laser beam 105 scans across build plane 145. Because the optical energy collected by the scanning and focusing system 115 travels a path that is near parallel to the laser beam, sensors 180 can be considered on-axis sensors.

In some embodiments, the additive manufacturing system can include off-axis sensors that are in a stationary frame of reference with respect to the laser beam 105. Additionally, there could be contact sensors on a recoater arm configured to spread metallic powders across build plane 145. These sensors could be accelerometers, vibration sensors, etc. Lastly, there could be other types of sensors such as thermocouples to measure macro thermal fields or could include acoustic emission sensors which could detect cracking and other metallurgical phenomena occurring in the deposit as it is being built.

In some embodiments, a computer 140, including a processor 2018, computer readable medium 190, an I/O interface 195, and a display device 2024 is provided and coupled to suitable system components of the additive manufacturing system in order to collect data from the various sensors. Data received by the computer 140 can include in-process raw sensor data and/or reduced order sensor data. The processor 2018 can use in-process raw sensor data and/or reduced order sensor data to determine laser 170 power and control information, including coordinates in relation to the build plane 145. In other embodiments, the computer 140, including the processor 185, computer readable medium 190, and an I/O interface 195, can provide for control of the various system components. The computer 140 can send, receive, and monitor control information associated with the laser 170, the build plane 145, and other associated components and sensors.

The processor 185 can be used to perform calculations using the data collected by the various sensors to generate in-process quality metrics. In some embodiments, data generated by on-axis optical sensors 180 can be used to determine thermal energy density during the build process. Control information associated with movement of the energy source across the build plane can be received by the processor. The processor can then use the control information to correlate data from on-axis optical sensor(s) and/or off-axis optical sensor(s) with a corresponding location. This correlated data can then be combined to calculate thermal energy density. In some embodiments, the thermal energy density and/or other metrics can be used by processor 185 to generate control signals for process parameters, for example, laser power, laser speed, hatch spacing, and other process parameters in response to the thermal energy density or other metrics falling outside of desired ranges. In this way, a problem that might otherwise ruin a production part can be ameliorated. In embodiments where multiple parts are being generated at once, prompt corrections to the process parameters in response to metrics falling outside desired ranges can prevent adjacent parts from receiving too much or too little energy from the energy source. In some embodiments, processor 185 can be used to run machine learning algorithms as described above. In some embodiments, processor 185 can be one or more processors.

In some embodiments, the I/O interface 195 can be configured to transmit data collected to a remote location. The I/O interface 195 can be configured to receive data from a remote location. The data received can include baseline datasets, historical data, post-process inspection data, and classifier data. The remote computing system can calculate in-process quality metrics using the data transmitted by the additive manufacturing system. The remote computing system can transmit information to the I/O interface in response to in-process quality metrics. It should be noted that the sensors described in conjunction with FIG. 7 can be used in the described ways to characterize performance of any additive manufacturing process involving sequential material build up.

In some embodiments, the display device 196 can be configured to display images captured by the imaging system 150 or optical sensors 180. Display device

While the embodiments described herein have used data generated by optical sensors to determine the thermal energy density, the embodiments described herein may be implemented using data generated by sensors that measure other manifestations of in-process physical variables. Sensors that measure manifestations of in-process physical variables include, for example, force and vibration sensors, contact thermal sensors, non-contact thermal sensors, ultrasonic sensors, and eddy current sensors. It will be apparent to one of ordinary skill in the art that many modifications and variations are possible in view of the above teachings.

The various aspects, embodiments, implementations, or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom” or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

What is claimed is:

1. A computer-implemented method, comprising:
accessing, by a computer of an additive manufacturing system, a machine learning model that is trained to identify defects within a build plane;
capturing, by an imaging system of the additive manufacturing system, an image of the build plane of the additive manufacturing system, the build plane comprising a layer of powder extending across one or more objects being manufactured through an additive manufacturing process;
providing, by the computer, the captured image as an input to the machine learning model; and
receiving, by the computer, an output from the machine learning model identifying a defect in the build plane.

2. The method of claim 1, further comprising:
determining, by the computer, if the defect can be corrected.

3. The method of claim 2, further comprising:
generating, by the computer, one or more control signals for one or more in process parameters in response a determination that the identified defect can be corrected, the one or more control signals configured to correct the defect.

4. The method of claim 2, further comprising:
terminating, by the computer, the additive manufacturing process in response to a determination that the identified defect cannot be corrected.

5. The method of claim 1, wherein the receiving further comprises:
providing, by the computer, the output of the machine learning model to a display device of the additive manufacturing system.

6. The method of claim 1, wherein the output from the machine learning model includes a defect type for the identified defect.

7. The method of claim 1, wherein accessing the machine learning model further comprises:
selecting, by the computer, the machine learning model from a model warehouse based on at least one of a part geometry, a powder bed layout, a powder material, a lighting angle, or a lighting type.

8. An additive manufacturing system comprising:
one or more processors configured to:
access a machine learning model that is trained to identify defects within a build plane;
capture, by an imaging system of the additive manufacturing system, an image of a build plane of the additive manufacturing system, the build plane comprising a layer of powder extending across an object being manufactured through an additive manufacturing process;
provide the captured image as an input to the machine learning model; and
receive an output from the machine learning model identifying a defect in the build plane.

9. The system of claim 8, wherein the system is further configured to:
determine, using the output, if the defect can be corrected.

10. The system of claim 9, wherein the system is further configured to:
generate one or more control signals for one or more in process parameters in response a determination that the identified defect can be corrected, the one or more control signals configured to correct the defect.

11. The system of claim 9, wherein the system is further configured to:
terminate, by the processor, the additive manufacturing process in response to a determination that the identified defect cannot be corrected.

12. The system of claim 8, wherein the system is further configured to:
provide the output of the machine learning model to a display device of the additive manufacturing system.

13. The system of claim 8, wherein the output from the machine learning model includes a defect type for the identified defect.

14. The system of claim 8, wherein the system is further configured to:
select the machine learning model from a model warehouse based on at least one of a part geometry, a powder bed layout, a powder material, a lighting angle, or alighting type.

15. A non-transitory computer-readable medium storing a set of instructions, the set of instructions comprising:
one or more instructions that, when executed by one or more processors of a computer of an additive manufacturing system, cause the computer to:
access a machine learning model that is trained to identify defects within a build plane;
receive, from an imaging system of the additive manufacturing system, an image of a build plane of the additive manufacturing system, the build plane comprising a layer of powder extending across an object being manufactured through an additive manufacturing process;
provide the received image as an input to the machine learning model; and
receive an output from the machine learning model identifying a defect in the build plane.

16. The non-transitory computer-readable medium of claim 15, wherein the instructions further cause the computer to:
determine, using the output, if the defect can be corrected.

17. The non-transitory computer-readable medium of claim 16, wherein the instructions further cause the computer to:
generate one or more control signals for one or more in process parameters in response a determination that the identified defect can be corrected, the one or more control signals configured to correct the defect.

18. The non-transitory computer-readable medium of claim 16, wherein the instructions further cause the computer to:
terminate the additive manufacturing process in response to a determination that the identified defect cannot be corrected.

19. The non-transitory computer-readable medium of claim 15, wherein the instructions further cause the computer to:
provide the output of the machine learning model to a display device of the additive manufacturing system.

20. The non-transitory computer-readable medium of claim 15, wherein the output from the machine learning model includes a defect type for the identified defect.
